(19) United States
(12) Patent Application Publication
(10) Pub. No.: US 2017/0147267 A1
(43) Pub. Date: May 25, 2017

(54) INFORMATION OUTPUT APPARATUS, METHOD FOR OUTPUTTING INFORMATION, AND NON-TRANSITORY COMPUTER-READABLE MEDIUM

(71) Applicant: Hideki YANAGI, Kanagawa (JP)

(72) Inventor: Hideki YANAGI, Kanagawa (JP)

(21) Appl. No.: 15/340,575

(22) Filed: Nov. 1, 2016

(30) Foreign Application Priority Data
Nov. 20, 2015 (JP) 2015-227484

(51) Int. Cl. G06F 3/12; H04N 1/327; H04N 1/32; H04N 1/00; G06K 9/00

(52) U.S. Cl. CPC G06F 3/1243; H04N 1/00795; H04N 1/00442; G06K 9/00469; H04N 1/32133; H04N 1/32771; G06F 3/1208; G06F 3/1236; G06F 3/1285; H04N 2201/0094

(57) ABSTRACT

An information output apparatus includes a reader, circuitry, and an output device. The reader is configured to read user information from a recording medium storing the user information. The circuitry is configured to select, from a plurality of documents, one or more documents to be embedded with the user information as a selected document, determine whether the information output apparatus is connected to a network, instruct the reader to read the user information from the recording medium based on a determination indicating that the information output apparatus is not connected to the network, and embed the user information that is read from the recording medium in a specific area of the selected document. The output device is configured to output the selected document having the user information embedded therein.

### CROSS-REFERENCE TO RELATED APPLICATIONS

This patent application is based on and claims priority pursuant to 35 U.S.C. §119(a) to Japanese Patent Application No. 2015-227484, filed on Nov. 20, 2015 in the Japan Patent Office, the entire disclosure of which is hereby incorporated by reference herein.

### BACKGROUND

Technical Field

The present disclosure relates to an information output apparatus, a method for outputting information, and a non-transitory computer-readable medium.

Description of the Related Art

In many business scenes, users are required to fill in their personal information on an application form and print out the application form for submission. As the users are required to handwrite their personal information, this work of filling out the application form is bothersome. In addition, the users may sometimes make mistakes when handwriting their personal information.

### SUMMARY

An information output apparatus includes a reader, circuitry, and an output device. The reader is configured to read user information from a recording medium storing the user information. The circuitry is configured to select, from a plurality of documents, one or more documents to be embedded with the user information as a selected document, determine whether the information output apparatus is connected to a network, instruct the reader to read the user information from the recording medium based on a determination indicating that the information output apparatus is not connected to the network, and embed the user information that is read from the recording medium in a specific area of the selected document. The output device is configured to output the selected document having the user information embedded therein.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating a configuration of a network system to which an information output system is applied according to an embodiment of the present invention;

FIG. 2 is a block diagram illustrating a hardware configuration of an information output apparatus according to an embodiment of the present invention;

FIG. 3 is a block diagram illustrating a hardware configuration of an information output system according to an embodiment of the present invention;

FIG. 4 is a block diagram illustrating a software configuration of a multifunction peripheral (MFP) as an example of the information output apparatus according to an embodiment of the present invention;

FIG. 5 is a block diagram illustrating an example of a functional configuration of the MFP according to an embodiment of the present invention;

FIG. 6 is a flowchart illustrating an operation performed by the MFP having the functional configuration as illustrated in FIG. 5;

FIGS. 7A to 7E are views, each illustrating an example of a screen displayed on a control panel of the MFP according to an embodiment of the present invention;

FIGS. 8A to 8C are views, each illustrating an example of a form as a template in which information is to be embedded according to an embodiment of the present invention;

FIG. 9 is a table illustrating an example of information constituting the form according to an embodiment of the present invention;

FIG. 10 is a table illustrating an example of user information according to an embodiment of the present invention;

FIG. 11 is a view illustrating an example of a screen for selecting a server or a personal information card according to an embodiment of the present invention;

FIG. 12 is a block diagram illustrating another example of the functional configuration of the MFP according to an embodiment of the present invention;

FIG. 13 is a view illustrating an example of a personal information card as an example of a recording medium storing the user information according to an embodiment of the present invention;

FIG. 14 is a flowchart illustrating an operation of embedding the user information in the form according to an embodiment of the present invention;

FIGS. 15A and 15B are a sequence diagram illustrating an operation performed by the MFP having the functional configuration as illustrated in FIG. 12;

FIGS. 16A and 16B are views, each illustrating an example of the form output by the MFP having the configuration as illustrated in FIG. 12;

FIGS. 17A and 17B are a sequence diagram illustrating an operation performed by the MFP having the functional configuration as illustrated in FIG. 12;

FIG. 18 is a view illustrating an example of another screen displayed on the control panel of the MFP according to an embodiment of the present invention;

FIG. 19 is a block diagram illustrating still another example of the functional configuration of the MFP according to an embodiment of the present invention;

FIGS. 20A to 20D are views, each illustrating an example of a screen displayed on the control panel of the MFP when correcting the user information embedded in the form according to an embodiment of the present invention, and

FIGS. 21A and 21B is a sequence diagram illustrating an operation performed by the MFP having the functional configuration as illustrated in FIG. 19.

The accompanying drawings are intended to depict embodiments of the present invention and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Several exemplary embodiments of the present invention are described hereinafter with reference to drawings.

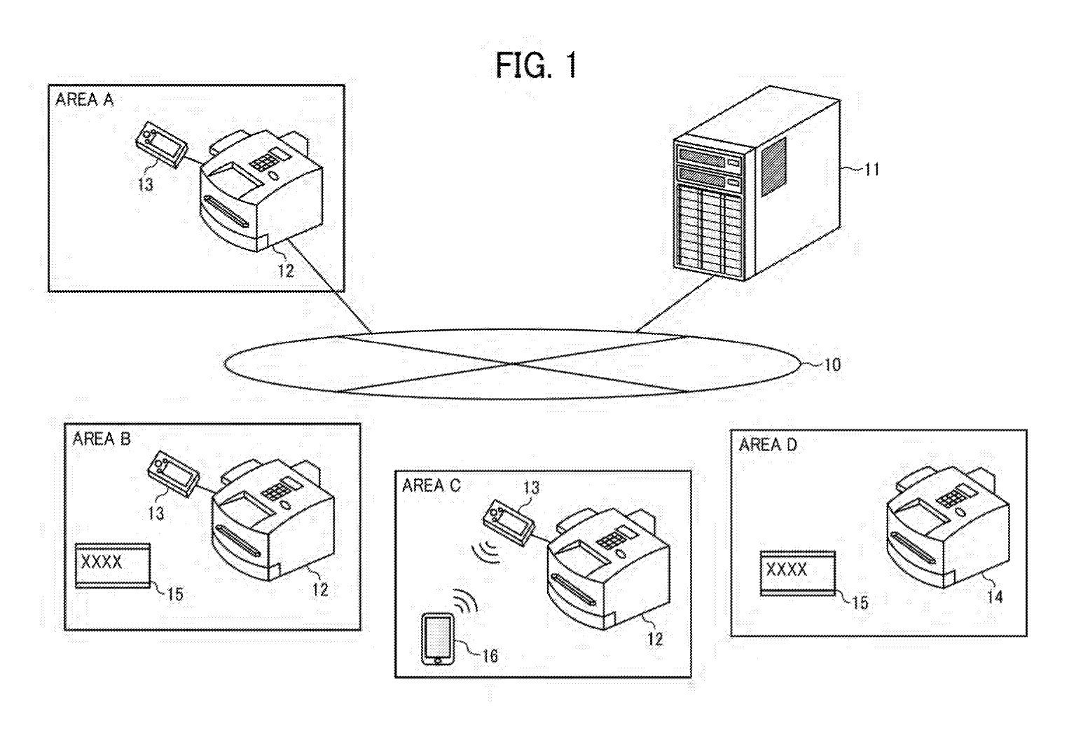

FIG. 1 is a schematic diagram illustrating a configuration of a network system to which an information output system is applied according to an embodiment of the present invention. The network system of FIG. 1 includes a server 11 and at least one of an information output system and an information output apparatus. The server 11 is connected to a network 10 such as the Internet. The information output system and the information output apparatus could be more than one, each placed in each of remote places such as offices. In FIG. 1, four remote areas A to D are illustrated. The information output system in the area A is connected to the network 10. The information output systems in the area B and the area C, and the information output apparatus in the area D are disconnected from the network 10. In other words, the information output system and the information output apparatus in the areas B to D are configured and placed in an environment that cannot be connected to the network 10. Examples of the environment that cannot be connected to the network 10 include an area or a place where a communication infrastructure is not built, and a place to be insulated from the communication with the outside for security reasons, such as buildings of financial institutions, places where divisions or organizations that deal with personnel information reside. Further, even in a place where the communication infrastructure is build, if the communication infrastructure is not available as being under maintenance, etc., such place is regarded as the environment that cannot be connected to the network 10.

The server 11 communicates with an outside device connected to the network 10 to provide various information to the device. Example of the information that the server 11 provides to the outside device include user information such as a user name, user identification (ID), sex, address, phone number, office name, office address, title, and division.

In each of the area A to D, the information output system or the information output apparatus is placed. The information output system is constituted by an information processing apparatus and an image forming apparatus, for example. The information output system is, for example, an image forming apparatus having functions of the information processing apparatus. The image forming apparatus is, for example, a printer, a scanner, a facsimile, a copier, or a multifunction peripheral (MFP) having printer function, scanner function, facsimile function, and copier function. The image forming apparatus is just one example of the information output apparatus. Alternatively, the information output apparatus may be a projection apparatus that projects information to a screen or a display apparatus that displays information on a screen. Examples of the projection apparatus include a projector. Examples of the display apparatus include an electronic white board. The information processing apparatus is, for example, a dedicated control panel device, a smartphone, a personal digital assistant (PDA), or a tablet, each of which may be connected to the image forming apparatus via a cable, for example. Hereinafter, a description is given assuming that an MFP 12 is an example of the image forming apparatus, a control panel device 13 is an example of the information processing apparatus, and an MFP 14 is an example of the image forming apparatus having the functions of the information processing apparatus.

In each of the area A to C, there resides the information output system including the MFP 12 and the control panel device 13. In the area D, there resides the MFP 14 as an example of the information output apparatus. Further, FIG. 1 illustrates a personal information card 15 in each of the areas B and D. The personal information card 15 is an example of a recording medium storing user information of the user who owns the personal information card 15. Furthermore, FIG. 1 illustrates a communication terminal 16 having an integrated circuit (IC) chip as another example of the recording medium in the area C. The communication terminal 16 is, for example, an IC card, a cell phone, a smartphone, or a tablet.

The control panel device 13 includes a control panel that receives a user instruction for operation or data input. The control panel device 13 outputs the input data and the instruction or request to the MFP 12 to cause the MFP 12 to perform a predetermined operation. Further, the control panel device 13 displays a status of processing executed by the MFP 12 or an error status for notification to the user. The MFP 12 performs, for example, scanning of an image, printing, storing data, or communication with other devices. The MFP 14 is an image forming apparatus including the control panel. Accordingly, the MFP 14 is capable of performing the processing that the control panel device 13 and the MFP 12 perform as described above.

For example, a user in the area B uses the control panel device 13 to instruct the MFP 12 to perform printing or scanning of an image. In response to receiving the user instruction, the MFP 12 performs the printing or scanning of the image. The MFP 12 stores a plurality of template documents such as an application form. Hereinafter, the template document is referred to as a “form”. The user gives an instruction for selecting one of the forms using the control panel device 13. In response to the user instruction, the MFP 12 outputs the selected form having the user information embedded therein.

In a case in which the MFP 12 is connected to the network 10 as in the area A, the MFP 12 connects to the server 11 to acquire the user information from the server 11. The MFP 12 embeds the acquired user information in the selected form and prints out the form having the user information embedded therein. By contrast, as the areas B to D are disconnected from the network 10, the MFP 12 and the MFP 14 cannot acquire the user information from the server 11. To address this issue, in the areas B to D, the MFP 12 and the MFP 14 acquire the user information from the personal information card 15 or the communication terminal 16.

Specifically, the MFP 12 in the area B and the MFP 14 have scanner function, and read the user information from the personal information card 15 with the scanner function. The MFP 12 in the area C has a wireless communication function, and acquires the user information from the communication terminal 16 with the wireless communication function. The MFP 12 and the MFP 14 embed the acquired user information in one or more specific areas of the form selected by the user. Further, the MFP 12 and the MFP 14 print out the form having the user information embedded therein. Otherwise, the control panel device 13 may include a camera. In this case, the user information is acquired from an image of the personal information card 15 captured by the camera. Note that the camera is not necessarily included in the control panel device 13, the MFP 12 or the MFP 14. In this case, the camera as an example of a reader to read the user information is connected to the MFP 12 or the MFP 14.

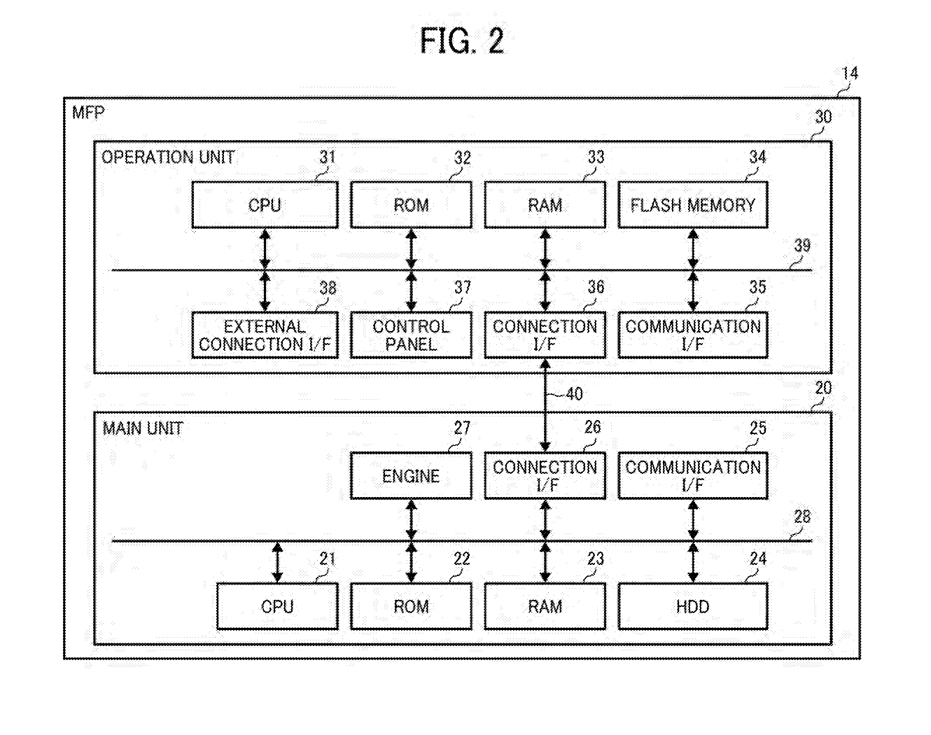

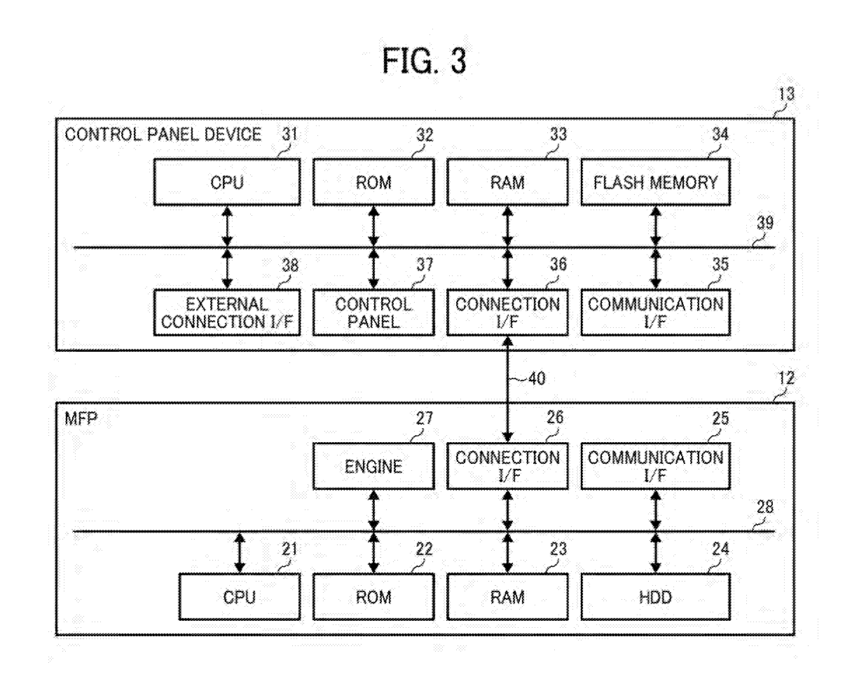

FIGS. 2 and 3 are block diagrams illustrating hardware configurations of the information output apparatus and the information output system respectively that can perform processing as described above. FIG. 2 illustrates a hardware configuration of the MFP 12 as an example of the information output apparatus. FIG. 3 illustrates a hardware configuration of the MFP 12 and the control panel device 13 that constitute the information output system. As illustrated in FIG. 2, the MFP 12 includes a main unit 20 and an operation unit 30. The main unit 20 corresponds to the MFP 12 illustrated in FIG. 3. The operation unit 30 corresponds to the control panel device 13 illustrated in FIG. 3. Accordingly, the MFP 14 illustrated in FIG. 2 and the information output system illustrated FIG. 3 have same hardware components. Therefore, a description is given of a hardware configuration of the MFP 14 with reference to FIG. 2, and the description of the hardware configurations of the MFP 12 and the control panel device 13 is omitted.

The main unit 20 has various functions such as the copier function, the scanner function, the facsimile function, and the printer function. The main unit 20 is connected to the operation unit 30 through a dedicated communication path 40. The communication path 40 may be in compliance with a universal serial bus (USB) standard. However, any arbitrary standard may be used as the communication path 40. Further, the communication path 40 may be either wired or wireless.

The main unit 20 operates in accordance with a user's operation received by the operation unit 30. The main unit 20 is also capable of communicating with an external apparatus such as a client personal operation unit (PC) and operating in response to an instruction received from the external apparatus.

The main unit 20 includes a central processing unit (CPU) 21, a read only memory (ROM) 22, a random access memory (RAM) 23, a hard disk drive (HDD) 24, and a communication interface (I/F) 25, a connection I/F 26, and an engine 27, which are connected with one another via a system bus 28. The CPU 21 controls the entire operation of the main unit 20 by executing programs stored in the ROM 22 or the HDD 24, etc., using the RAM 23 as a work area, to implement various functions such as the copier function, the scanner function, the facsimile function and the printer function as described above.

The communication I/F 25 is an interface for connecting the main unit 20 to the network 10. The connection I/F 26 is an interface for allowing the main unit 20 to communicate with the operation unit 30 via the communication path 40.

The engine 27 is hardware for performing processing other than data communication and general information processing to implement the copier function, the scanner function, the facsimile function or the printer function. The engine 27 includes a scanner as an example of a reader that reads an image on a document to output image data, a plotter that forms an image on a sheet material such as paper, and a facsimile unit that performs facsimile communication. The engine 27 may further include optional equipment such as a finisher that sorts the printed sheet materials, and an automatic document feeder (ADF) that automatically feeds documents to be scanned. For scanning, the document is placed on an exposure glass of the MFP 14, for example. Alternatively, the ADF sequentially feeds the document placed on a document tray to a scan position.

The operation unit 30 includes a CPU 31, a ROM 32, a RAM 33, a flash memory 34, a communication I/F 35, a connection I/F 36, a control panel 37, and an external connection I/F 38, which are connected with one another via a system bus 39.

The CPU 31 controls entire operation of the operation unit 30. More specifically, the CPU 31 executes programs stored in the ROM 32 or the flash memory 34 using the RAM 33 as a work area to control entire operation of the operation unit 30. Further, the CPU 31 executes the programs to implement, for example, displaying of information or images in accordance with a user instruction input through the control panel 37.

The communication I/F 35 is an interface for connecting the operation unit 30 to the network 10. The connection I/F 36 is an interface for allowing the operation unit 30 to communicate with the main unit 20 via the communication path 40.

The control panel 37 receives various inputs in response to the user's operation and displays various information. For example, the control panel 37 displays information corresponding to the received instructions, information indicating an operational status of the main unit 20, and information indicating a setting status.

The control panel 37 is implemented by a liquid crystal display (LCD) having a touch panel, however, such a LCD is exemplary. Alternatively, for example, the control panel 37 may be implemented by an organic electro luminescence (EL) display having a touch panel. The control panel 37 may include, instead of or in addition to the touch panel, an operation unit such as hardware keys and/or a display unit such as an indicator lamp.

The external connection I/F 38 is an interface for connecting the operation unit 30 with external hardware. Examples of the external hardware include a data storage device such as a universal serial bus (USB) memory and an external HDD, an audio input device, an audio output device, a projector, an electronic white board, and a digital camera.

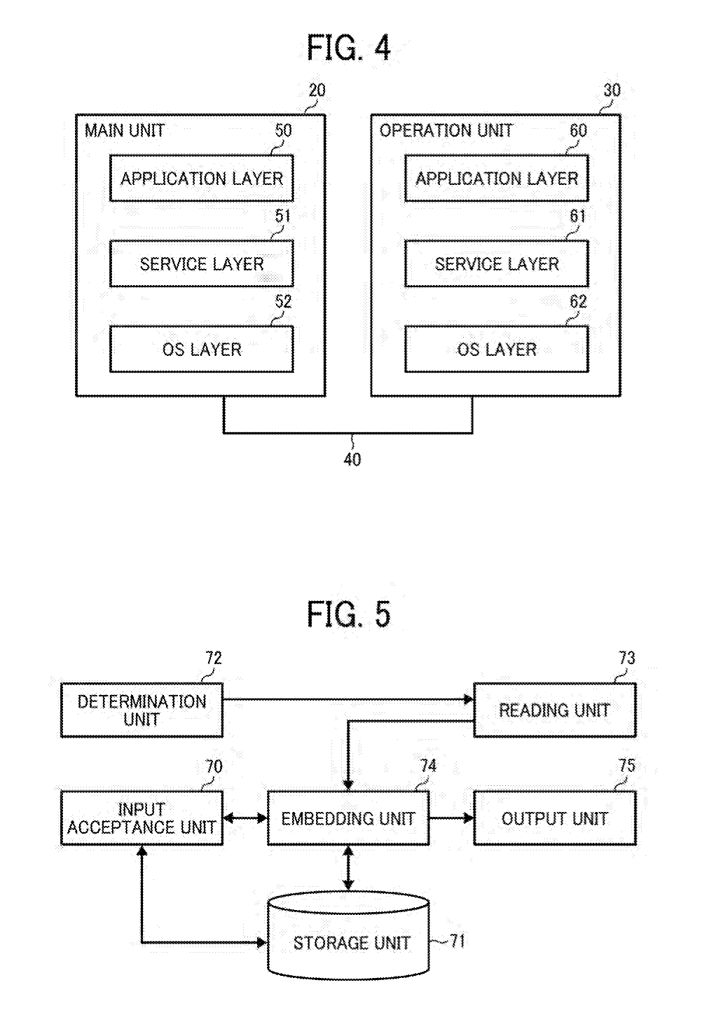

Hereinafter, a description is given of software implemented in the WP 14 with reference to FIG. 4. The main unit 20 includes an application layer 50, a service layer 51 and an operation system (OS) layer 52. The entities of the application layer 50, the service layer 51 and the OS layer 52 are the programs stored in the ROM 22 or the HDD 24. The CPU 21 executes the programs to implement each of the above-described functions.

The application layer 50 includes an application that causes hardware resources to operate so as to provide predetermined functions. Examples of the applications of the application layer 50 include a copy application that provides the copier function, a scanner application that provides the scanner function, a facsimile application that provides the facsimile function, and a printer application that provides the printer function.

The service layer 51, which is provided between the application layer 50 and the OS layer 52, includes software that provides each application with an interface for using the hardware resources of the main unit 20. More specifically, the software of the service layer 51 provides functions of receiving operation requests to the hardware resources and mediating the operation requests. Examples of the operation requests that the service layer 51 receives may include a request for scanning by the scanner and a request for printing by the plotter.

The interface function by the service layer 51 may be also provided to an application layer 60 of the operation unit 30 as well as the application layer 50 of the main unit 20. A detailed description is given later of the application layer 60. Accordingly, the application layer 60 of the operation unit 30 is also capable of implementing functions that use the hardware resources such as the engine 27 of the main unit 20 via the interface function of the service layer 51.

The OS layer 103 includes basic software (operating system) that provides basic functions of controlling the hardware of the main unit 20. The service layer 51 converts each of the requests received from the applications of the application layer 50 for using the hardware resources, to a command that is interpretable by the OS layer 52. The service layer 51 passes the command to the OS layer 52. In response to receiving the command, the OS layer 52 executes the command to allow the hardware resources to operate in accordance with the request by the application.

The operation unit 30 similarly includes the application layer 60, a service layer 61 and an OS layer 62. The application layer 60, the service layer 61 and the OS layer 62 of the operation unit 30 has a similar layer structure to that of the main unit 20. However, the application layer 60 includes applications different from those of the application layer 50 of the main unit 20. This is because the functions provided by the applications of the application layer 60 and operation requests to be received by the service layer 61 are different from those of the main unit 20.

The application of the application layer 60 includes software for implementing a user interface (UI) function for operating or displaying the functions that the main unit 20 includes. Note that the application of the application layer 60 may be software that causes hardware resources of the operation unit 30 to operate so as to implement predetermined functions.

The application layer 60 includes, in addition to the software for implementing the UI function, an application for implementing reading of the user information, embedding the user information in the form, and printing out the form as described later.

Although a description has been given the software implemented on the MFP 14 having the hardware configuration as illustrated in FIG. 2, the information output system having the hardware configuration as illustrated in FIG. 3 includes the similar or substantially the similar software of the MFP 14 as illustrated in FIG. 4. In other words, the main unit 20 and the operation unit 30 respectively operate on different operating systems. Accordingly, communication between the main unit 20 and the operation unit 30 is conducted as communications between separate apparatuses, instead of interprocess communication within a common apparatus. Examples of the communication between the main unit 20 and the operation unit 30 include command communication, which is an operation of transmitting the information (e.g., instruction contents) received by the operation unit 30 to the main unit 20. Examples of the communication between the main unit 20 and the operation unit 30 further include an operation by the main unit 20 of notifying the operation unit 30 of an event.

The operation unit 30 communicates commands to the main unit 20 to use the functions of the main unit 20. Further, the operation unit 30 receives the events notified from the main unit 20 to display an execution status of operation in the main unit 20 and contents that are set in the main unit 20.

Power is supplied from the main unit 20 to the operation unit 30 via the communication path 40. Accordingly, the power control of the operation unit 30 may be performed independently from the power control of the main unit 20.

Hereinafter, a description is given of a functional configuration of the MFP 14 as an example of the information output apparatus with reference to FIG. 5. Note that a combination of the MFP 12 and the control panel device 13 constituting the information output system has the same or substantially the same functional configuration as that of the MFP 14. The MFP 14 includes an input acceptance unit 70, a storage unit 71, a determination unit 72, a reading unit 73, an embedding unit 74, and an output unit 75. The input acceptance unit 70, the determination unit 72, and the embedding unit 74 are each implemented by the operation unit 30 illustrated in FIG. 2.

The storage unit 71 is implement by the RAM 33 and the flash memory 34 of the operation unit 30, and the RAM 23 and the HDD 24 of the main unit 20. The functional blocks other than the storage unit 71 are implemented by the CPU 21, when executing the program stored in the HDD 24 to cause the engine 27 to operate, or the CPU 31, when executing the program stored in the flash memory 34.

Note that a part of these functional blocks may be implemented by a dedicated hardware circuit. Further, although a description has been given of an example in which the main unit 20 and the operation unit 30 operate independently with each other on separate operation systems, the main unit 20 and the operation unit 30 may operate on the same operation system.

Furthermore, the program for implementing the above-described functional blocks is a file in installable or executable format. This program can be provided using any storage medium readable by a computer, such as a compact disc (CD) ROM, a flexible disc, a CD-R, a CD-RW, a digital versatile disk (DVD), a USB memory, and a SD card. This program may be provided by incorporating the program in a nonvolatile storage medium such as a ROM in advance.

In response to a user instruction, the input acceptance unit 70 acquires, from the storage unit 71, a plurality of forms in which the user information to be embedded. Further, the input acceptance unit 70 displays the acquired forms on the control panel 37 to present the forms to the user. The input acceptance unit 70 accepts a user instruction for selecting one or more forms from the plurality of forms presented to the user. The form is a template document such as an application form including blank areas for the user information such as a user name or an address. In other words, for each form, types of the user information to be embedded in the form are associated with areas in which the user information is to be embedded. The storage unit 71 stores the plurality of forms. Further, the storage unit 71 stores a list of the plurality of forms.

The determination unit 72 determines whether the MFP 14 is connected to the network 10 to acquire the user information. Specifically, the MFP 14 sends a connection request to the network 10 to determine whether the MFP 14 is connected to the network 10 based on a determination of whether a reply to the connection request is sent back from the network 10 within a predetermined period of time. Note that the above-described determination as to whether the MFP 14 is connected to the network 10 is just one example, and the determination may be made in any other desired manner. The determination unit 72 may instruct the control panel 37 to display an image or a message indicating that the MFP 14 is not connected to the network 10 to give the notification to the user.

In response to this notification, the user places the personal information card 15 at a read position such as on the exposure glass or on the document tray of the ADF. The reading unit 73 reads the user information from the personal information card 15 placed at the read position. The personal information card 15 is an example of a recording medium having the user information recorded thereon. The user information includes the user name, user ID, sex, address, and phone number as described above. The personal information card 15 is a paper medium having the user information printed thereon.

The embedding unit 74 embeds the user information read by the reading unit 73 in specific areas in one or more forms selected in accordance with the user instruction accepted by the input acceptance unit 70. Each form includes one or more blank areas in which the user information is to be embedded. Each blank area is assigned with an identification information for identifying the user information. The identification information is a category indicating a classification of information such as a name, an ID, a sex, an address, and a phone number. The user information read from the personal information card 15 is also associated with the category.

The embedding unit 74 determines, for each selected form, whether the form includes one or more area, in which the user information is to be embedded. When the embedding unit 74 determines that the form includes one or more areas in which the user information is to be embedded, the embedding unit 74 obtains, for each area, the category assigned to that area, and retrieves the user information corresponding that category from the user information read by the reading unit 73. Further, the embedding unit 74 overlays the retrieved user information on the corresponding area to embed the user information in the form. The embedding unit 74 repeats this processing for each area to embed the user information in all of the areas. Further, the embedding unit 74 generates data of the form for output having the user information embedded in all of the areas.

The output unit 75 outputs one or more forms having the user information embedded therein for printing out, facsimile transmission, or to be stored in a storage device, for example. The output unit 75 may temporarily stores, in the storage device, the data of one or more forms having the user information embedded therein for printing out the form at later time. The storage device is, for example, the HDD 24 of the main unit 20 or the flash memory 34 of the operation unit 30. Alternatively, the storage device may be an external storage device such as USB memory or an external HDD. Accordingly, the form having the user information embedded therein may be stored in a USB memory, and the form may be printed out from another printer to which the USB memory is connected. Hereinafter, a description is given assuming that the output is printing out unless otherwise described.

Hereinafter, a description is given of an operation performed by the MFP 14 having the functional configuration as illustrated in FIG. 5. The processing starts, when the input acceptance unit 70 accepts the user instruction input through the control panel 37 for selecting the form and selecting whether to embed the user information in the form. At S605, the determination unit 72 determines whether to embed the user information in the form and print out the form based on the instruction accepted by the input acceptance unit 70. When the determination unit 72 determines that the user information is to be embedded in the form and printed out (S605: YES), the processing proceeds to S610. By contrast, when the determination unit 72 determines that the user information is not to be embedded in the form based on the user instruction (S605: NO), the processing proceeds to S630.

At S610, the determination unit 72 determines whether the MFP 14 is connected to the network 10. For example, the determination unit 72 sends the connection request to the network 10 to make this determination as described above. When the determination unit 72 determines that the MFP 14 is connected to the network 10 (S610: YES), the processing proceeds to S615. By contrast, when the determination unit 72 determines that the MFP 14 is not connected to the network 10 (S610: NO), the processing proceeds to S620. At S615, as the MFP 14 is connected to the network 10 to which the server 11 that stores the user information is connected, the MFP 14 communicates with the server 11 via a communication unit to acquire the user information from the server 11.

Specifically, the MFP 14 requests a user to enter information such as the user ID. The MFP 14 transmits, to the server 11, a user information acquisition request containing the entered information as a search keyword. The server 11 searches for the user information with the search keyword. Then, the server 11 transmits the search result to the MFP 14. Note that in a case in which the user has already logged in a service provided by the MFP 14 and the server 11 in advance, the MFP 14 acquires the user information from the server 11 using login information including the user ID without requiring the user to enter the user ID, etc.

At S620, as the MFP 14 is not connected to the network 10, the reading unit 73 reads and acquires the user information from the personal information card 15. In this case, as the MFP 14 is not required to retrieve the user information from the server 11, the MFP 14 does not request the user to enter the user ID, etc. In this embodiment, although the MFP 14 acquires the user information from the personal information card 15, the MFP 14 may acquire the user information from the communication terminal 16.

At S625, the embedding unit 74 embeds the user information in the specific areas of the form as described above. At S630, the output unit 75 prints out the form having the user information embedded therein or the original form, i.e., the form having no user information embedded therein. Then, the processing ends.

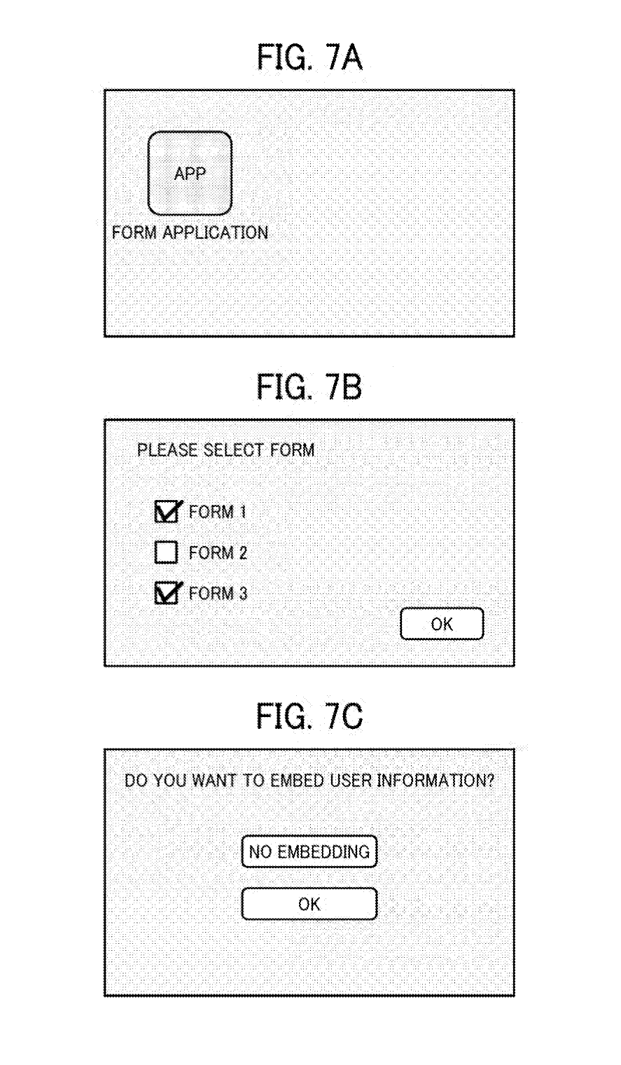

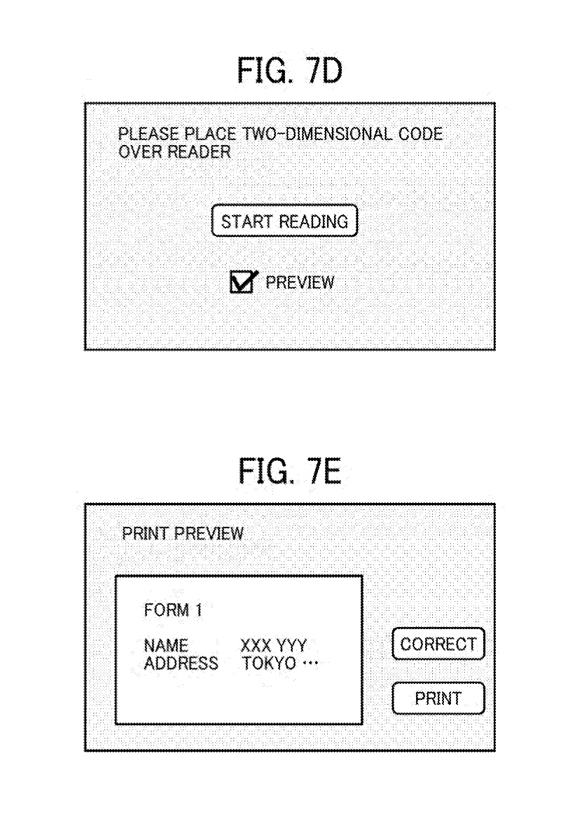

Note that the processing of S605 and the processing of S610 may be performed in an order different from the one described above. For example, in a case in which the determination of S605 is conducted after the determination of S610, the determination as to whether the user information is to be embedded can be made between S620 and S625. Accordingly, the control panel 37 does not display a screen as illustrated in FIG. 7C. In other words, a screen illustrated in FIG. 7B transit to a screen as illustrated in FIG. 7B to which a “NO EMBEDDING” key is added. The determination unit 72 determines whether to perform the embedding process based on whether the user selects the “NO EMBEDDING” key on that screen.

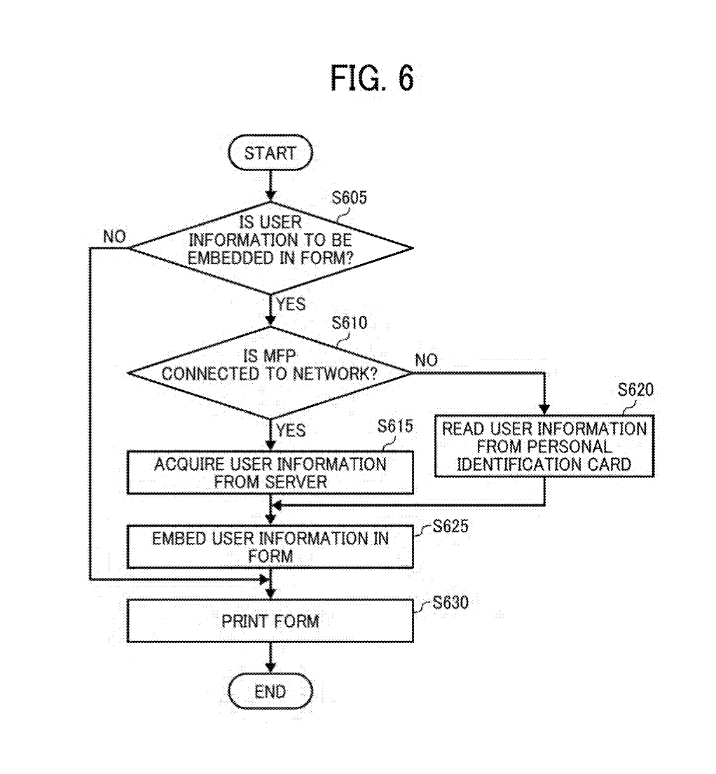

FIGS. 7A to 7E illustrate examples of a screen displayed on the control panel 37 when the MFP 14 performs the operation illustrated in FIG. 6. When the user wants to print out a desired form, the user selects an icon of a form application by tapping, touching, etc., to activate the form application. Note that the form is, for example, a document relating to business such as bills and quotes.

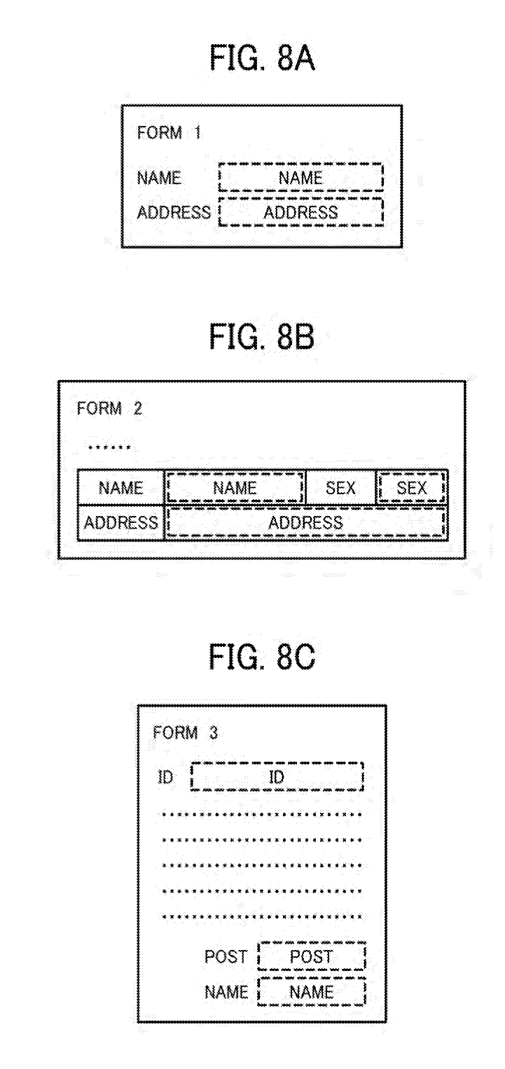

When the form application is activated, a screen that allows the user to select one or more forms is displayed as illustrated in FIG. 7B. FIGS. 8A to 8C illustrates example of the forms. As illustrated in FIG. 8A, Form 1 includes a character string “NAME” as the category followed by a blank area indicated by a dashed line, in which the acquired user information is to embedded. Further, below the “NAME”, Form 1 includes a character string “ADDRESS” as the category, followed by another blank area indicated by a dashed line, in which the acquired user information is to be embedded. As illustrated in FIG. 8B, Form 2 includes character strings “NAME”, “SEX”, and “ADDRESS”, each being a category, followed by blank areas indicated by a dashed line, in which the acquired user information is to be embedded. Further, as illustrated in FIG. 8C, Form 3 includes “ID”, “POST”, and “NAME”, each being a category, followed by blank areas, in which the acquired user information is to be embedded.

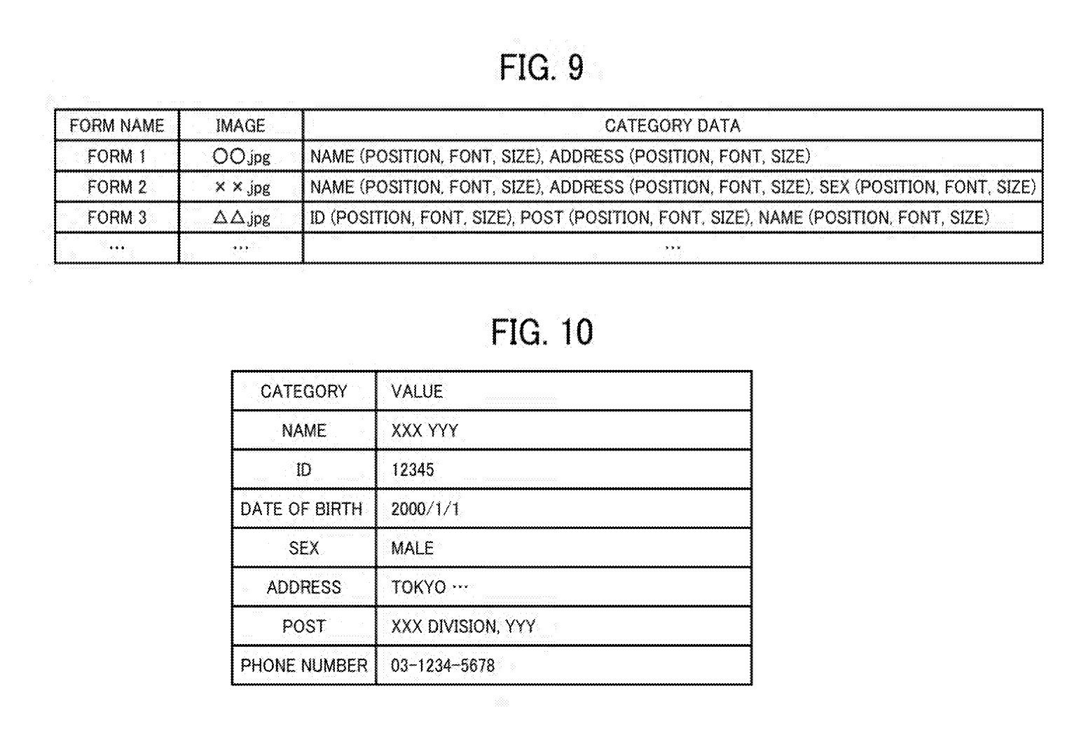

Each of these forms is displayed based on data as illustrated in FIG. 9. The data includes a form name for identifying the form, an image of the form, information of the position, font and size of characters indicating the category.

FIG. 10 illustrates an example of the user information in this embodiment. The user information includes a name, an ID, a date of birth, a sex, an address, a post, and a phone number, each being a category. A value is associated with each category. The value is, for example, a name of the user, a number identifying the user, etc.

Referring back to FIG. 7B, the user selects one or more forms that the user wants to print out from the plurality of forms displayed on the control panel 37. FIG. 7B illustrates an example in which the Form 1 and the Form 3 are selected. In response to the “OK” key being selected on the screen illustrated in FIG. 7B, the screen transits to a screen as illustrated in FIG. 7C that allows a user to select whether the user wants to embed the user information in the selected forms. When the user wants to print out the original form, the user selects a “NO EMBEDDING” key. Accordingly, the original form is printed out. By contrast, when the user wants to print out the form having the user information embedded therein, the user selects an “OK” key on the screen illustrated in FIG. 7C.

In response to the “OK” key being selected, the screen transits to a screen as illustrated in FIG. 7D. In this example, as the MFP 14 is not connected to the network 10, FIG. 7D illustrates an example of the screen for starting reading of the user information from the personal information card 15. The user places the personal information card 15 at the read position of the MFP 14 such as on the exposure glass and on the document tray of the ADF, and selects a “START READING” key on the screen illustrated in FIG. 7D. Accordingly, the process of reading of the user information form the personal information card 15 is started. Further, when the user fills a check box of “PREVIEW” with a check mark, a preview of a print result is displayed prior to printing out.

FIG. 7E illustrates an example of a screen displayed in a case in which the user marks the check box of the preview. Specifically, FIG. 7E illustrates a screen displaying a preview of the Form 1 having the acquired user information embedded therein. When the user agrees with the content displayed on the preview screen, the user selects a “PRINT” key to instruct printing out of the form. By contrast, when the name and/or the address embedded in the Form 1 needs to be corrected, the user selects a “CORRECT” key to correct the content. A detailed description is given later of the correction.

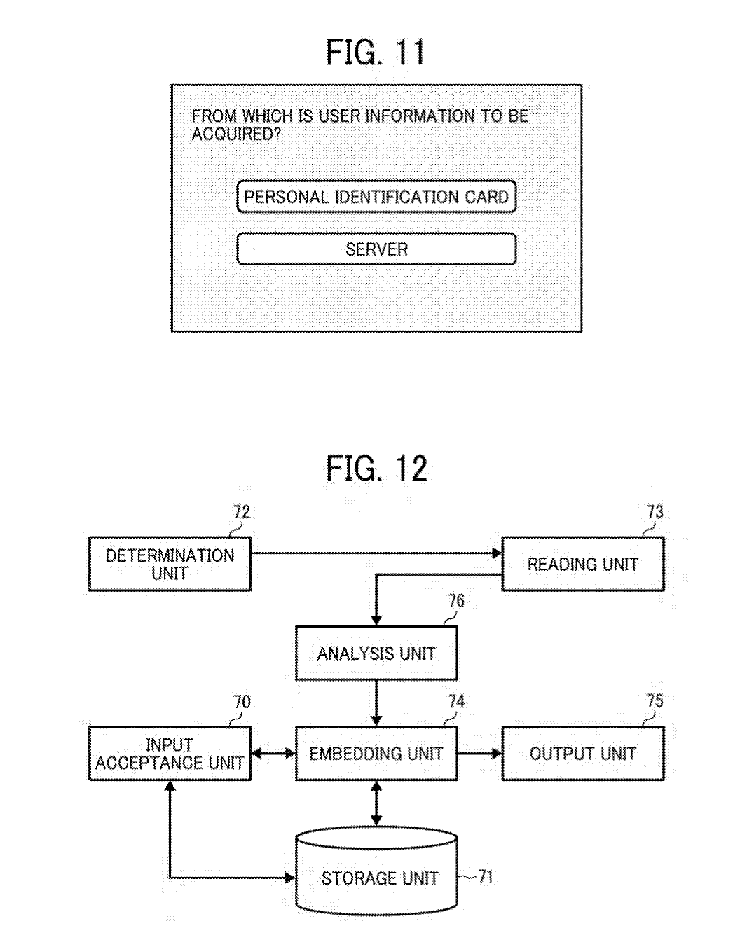

Heretofore, a description is given of an example in which either the acquisition of the user information from the server 11 or the reading out of the user information from the personal information card 15 is conducted based on the determination as to whether the MFP 14 is connected to the network 10. Alternatively, the user may select whether to cause the MFP 14 to acquire the user information from the server 11 or cause the MFP 14 to read the user information from the personal information card 15. In this case, after the “OK” key being selected on the screen illustrated in FIG. 7C, the screen transits to a screen as illustrated in FIG. 11, including a “SERVER” key and a “PERSONAL INFORMATION CARD” key. In response to the “SERVER” key being selected on the screen illustrated in FIG. 11, the screen transits a screen that requests the user to enter the ID. By contrast, in response to the “PERSONAL INFORMATION CARD” key being selected, the screen transits to the screen as illustrated in FIG. 7D that allows the user to instruct starting reading of a two-dimensional code.

Thus, the user information is acquired from the personal information card 15 even when the MFP 14 is connected to the network 10, when the MFP 14 has difficulty in communicating with the server 11 due to network congestion and therefore the MFP 14 is alike in the environment disconnected from the network 10.

FIG. 12 is a block diagram illustrating another example of the functional configuration of the MFP 14. In an example illustrated in FIG. 12, the MFP 14 further includes an analysis unit 76, in addition to the input acceptance unit 70, the storage unit 71, the determination unit 72, the reading unit 73, the embedding unit 74, and the output unit 75 illustrated in FIG. 5. Hereinafter a description is given of only the analysis unit 76, as the description of the other functional blocks has been already made above. Prior to the description of the analysis unit 76, a description is given of the personal information card 15 hereinafter.

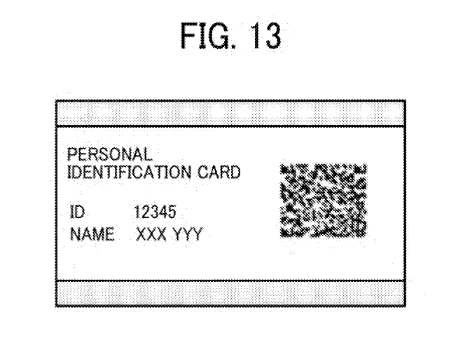

The personal information card 15 may be a card just listing the user information in association with the categories. Alternatively, as illustrated in FIG. 13, the personal information card 15 includes the user ID, the user name, and an image such as a two-dimensional code printed thereon. Note that the personal information card 15 containing these three items of the user information is just one example. The two-dimensional code illustrated in FIG. 13 is a QR code (registered trademark). The contents of the QR code include a name, an ID, a date of birth, a sex, an address, a post, and a phone number as illustrated in FIG. 10.

These items of the user information are converted into a data format such as the two-dimensional code, which is not perceptible to the naked human eye, to provide security of information. Although the QR code is described as an example of the two-dimensional code, any other two-dimensional code such as a color code may be used. Further, the two-dimensional code is just one example, and a one-dimensional code such as a bar code may be used.

Referring back to FIG. 12, the analysis unit 76 analyzes the two-dimensional code, etc., which is in a data format that is not perceptible to the naked human eye, to extract the user information. For example, the analysis unit 76 corrects the distortion or the tilt of the scanned two-dimensional code and converts the two-dimensional code to character strings by decoding to extract the user information. The analysis unit 76 passes the extracted user information to the embedding unit 74. In response to receiving the user information, the embedding unit 74 performs process of embedding the user information in the form.

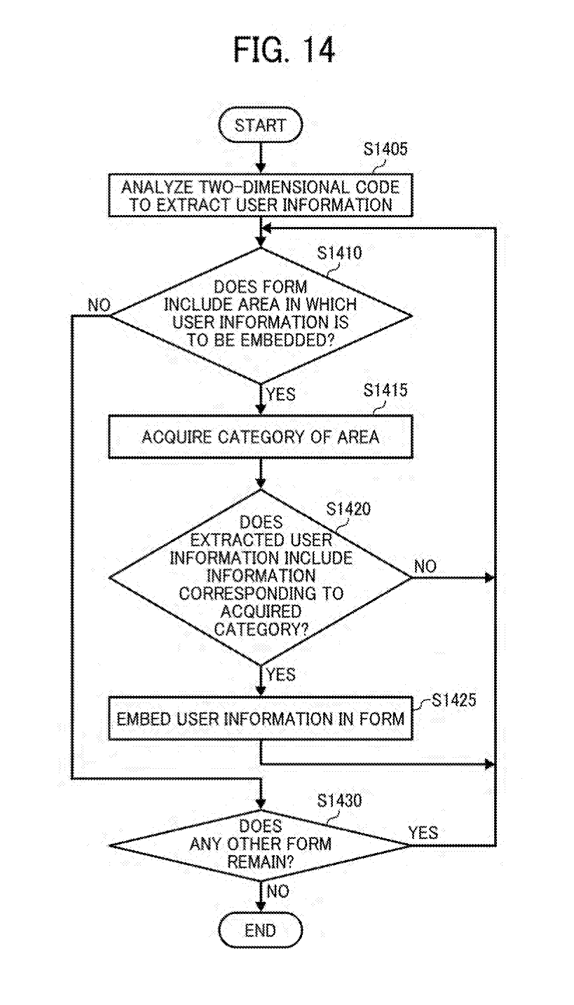

Hereinafter, a description is given of the embedding process with reference to FIG. 14. First, at S1405, the analysis unit 76 analyzes an image obtained by reading, with the scanner function of the MFP 14, the two-dimensional code as an example of the image that is not perceptible to the naked human eye, to extract the user information. At S1410, the embedding unit 74 determines whether the form selected by the user includes an area, in which the user information is to be embedded. When the embedding unit 74 determines that the form selected by the user includes the area in which the user information is to be embedded (S1410: YES), the processing proceeds to S1415. By contrast, when the embedding unit 74 determines that the form selected by the user includes no area in which the user information is to be embedded (S1410: NO), the processing proceeds to S1430.

At S1415, the embedding unit 74 acquires, from the form, the category assigned to the area in which the user information is to be embedded. At S1420, the embedding unit 74 determines whether the user information extracted by the analysis unit 76 includes information corresponding to the category. When the embedding unit 74 determines that the extracted information includes information corresponding to the category (S1420: YES), the processing proceeds to S1425. By contrast, when the embedding unit 74 determines that the extracted information includes no information corresponding to the category (S1420: NO), the processing returns back to S1410.

At S1425, the embedding unit 74 overlays the user information corresponding to the category on the corresponding area in the form to embed the user information in the form. After S1425, the processing returns back to S1410, and the embedding unit 74 determines the form includes another area in which the user information is to be embedded.

When the embedding unit 74 determines that the form includes no area in which the user information is to be embedded, in other words, when the form include no blank area in the first place or when all of the blank areas are filled in with the user information, the processing proceeds to S1430. At S1430, the embedding unit 74 determines whether another form selected by the user is present. When the embedding unit 74 determines that another form selected by the user is present (S1430: YES), the processing returns back to S1410. When the embedding unit 74 determines that another form selected by the user is not present (S1430: NO), the processing ends.

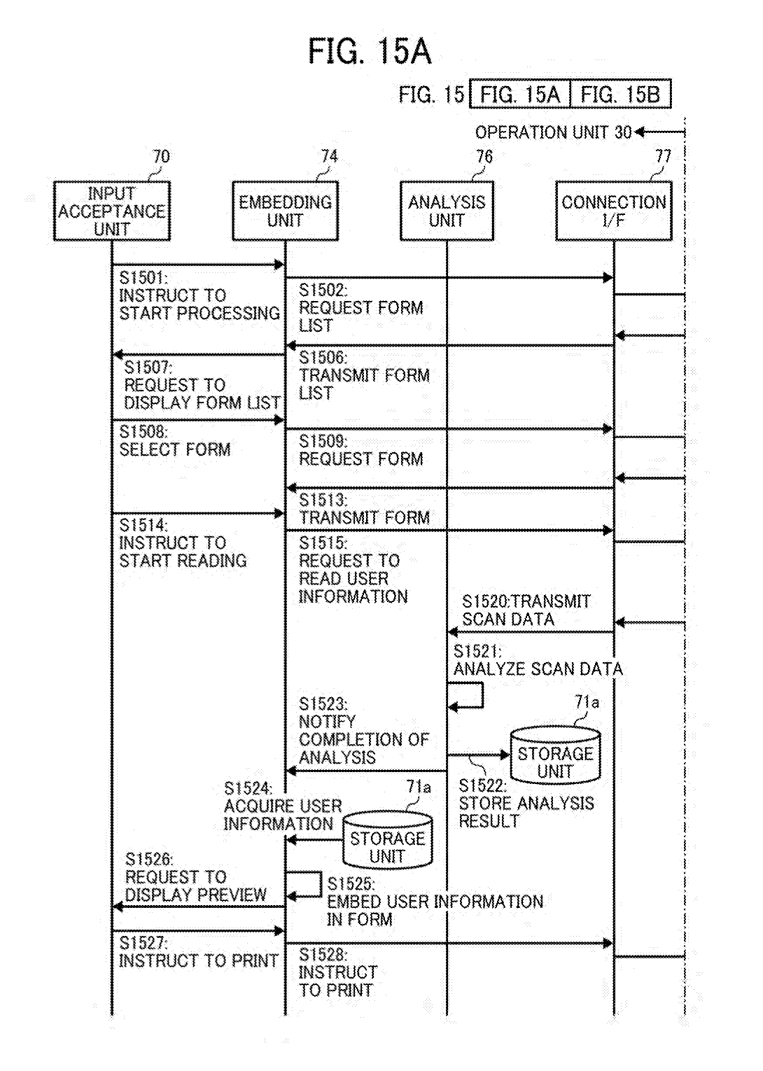

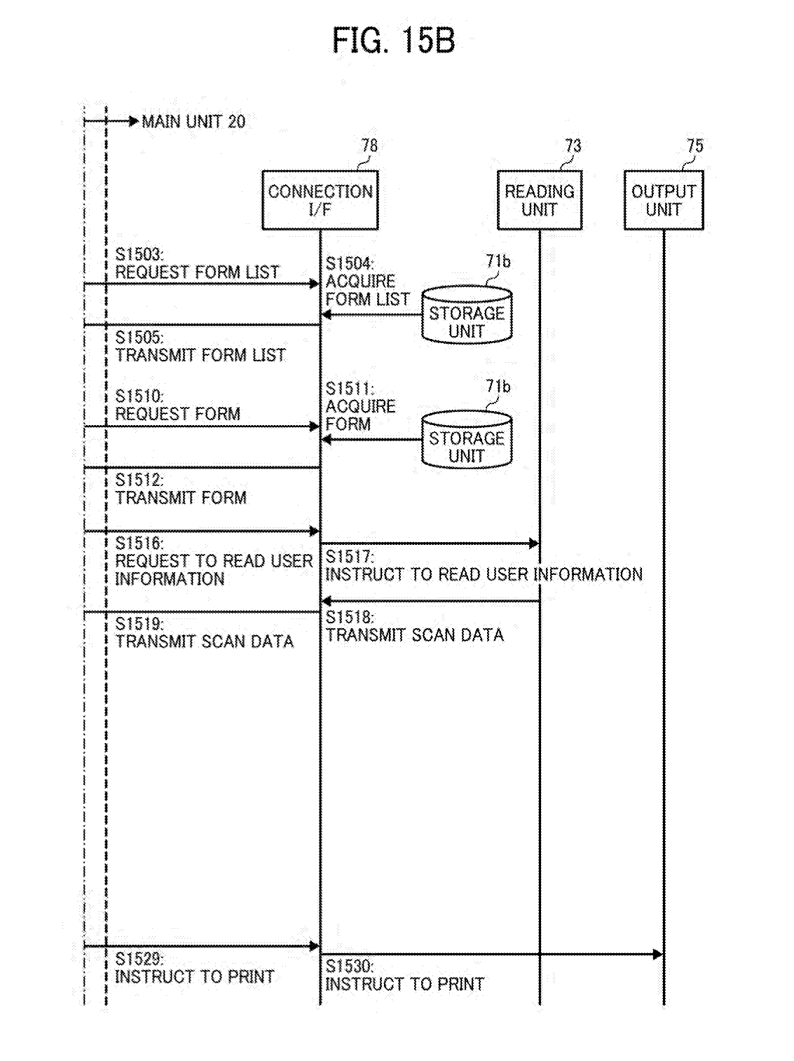

Heretofore a description has been given of the embedding process of the user information with reference to FIG. 14. Further, FIGS. 15A and 15B are a sequence diagram illustrating an entire operation performed by the MFP 14. As illustrated in FIGS. 15A and 15B, the input acceptance unit 70, a storage unit 71a, the embedding unit 74, and analysis unit 76 are included in the operation unit 30 of the MFP 14. Further, a storage unit 71b, the reading unit 73, and the output unit 75 are included in the main unit 20 of the MFP 14. The storage unit 71a is a part of the storage unit 71, and the storage unit 71b is another part of the storage unit 71. Furthermore, FIGS. 15A and 15B illustrate a connection I/F unit 77 as an interface unit to connect the operation unit 30 to the main unit 20, and a connection I/F unit 78 as an interface unit to connect the main unit 20 to the operation unit 30. The connection I/F unit 77 and the connection I/F unit 78 are implemented by the connection I/F 36 and the connection I/F 26 respectively.

In response to receiving a user instruction to start processing, the input acceptance unit 70 passes the user instruction to the embedding unit 74 (S1501). In an example of FIGS. 15A and 15B, it is assumed that the MFP 14 in not connected to the network 10. Accordingly, the determination as to whether the MFP 14 is connected to the network 10 and the acquisition of the user information from the server 11 are omitted from the sequence diagram of FIGS. 15 and 15B. The embedding unit 74 sends a request for the form list to the main unit 20 via the connection I/F unit 77 (S1502, S1503). In response to receiving the request, the connection I/F unit 78 of the main unit 20 acquires the form list from the storage unit 71b (S1504), and sends the form list to the connection I/F unit 77 as a reply to the request (S1505). The embedding unit 74 acquires the form list from the connection I/F unit 77 (S1506). Further, the embedding unit 74 requests the input acceptance unit 70 to display the form list (S1507). The input acceptance unit 70 causes the control panel 37 to display the form list to allow the user to select a desired form.

The input acceptance unit 70 accepts the user instruction for selecting the form (S1508). The embedding unit 74 sends a request for the selected from to the main unit 20 via the connection I/F unit 77 (S1509, S1510). The connection I/F unit 78 of the main unit 20 acquires the form designated by the request (S1511) from the storage unit 71a. Further, the connection I/F unit 78 sends the acquired form to the connection I/F unit 77 as a reply to the request (S1512). The embedding unit 74 acquires the form from the connection I/F unit 77 (S1513). In response to receiving a user instruction to start the reading process, the input acceptance unit 70 passes a read instruction for instructing reading of the user information to the embedding unit 74 (S1514).

In accordance with the read instruction, the embedding unit 74 requests the main unit 20 to read the user information via the connection I/F unit 77 (S1515, S1516). In response to receiving the request from the connection I/F unit 77, the connection I/F unit 78 of the main unit 20 instructs the reading unit 73 to read the user information (S1517). In response to the instruction, the reading unit 73 reads the user information from the personal information card 15, and sends back scan data as a read result to the connection I/F unit 78 (S1518). In response to receiving the scan data, the connection I/F unit 78 transmits the scan data to the operation unit 30 as a reply to the request (S1519).

In response to receiving the scan data, the connection I/F unit 77 of the operation unit 30 pass the scan data to the analysis unit 76 (S1520). The analysis unit 76 analyzes the scan data to extract the user information (S1521). The analysis unit 76 stores the extracted user information in the storage unit 71a (S1522). Further, the analysis unit 76 notifies the embedding unit 74 of a completion of the analysis (S1523). The embedding unit 74 acquires the user information stored in the storage unit 71a (S1524) and performs processing for embedding the user information in the form acquired at S1513 (S1525). Subsequently, the embedding unit 74 passes the form having the user information embedded therein to the input acceptance unit 70. The input acceptance unit 70 causes the control panel 37 to display the preview screen as illustrated in FIG. 7E (S1526).

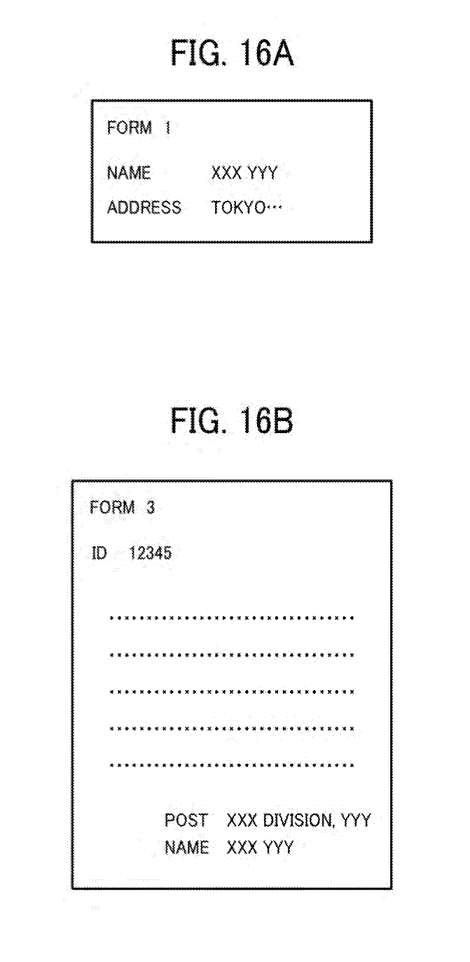

In response to receiving a user instruction for printing out the form, the input acceptance unit 70 sends a print instruction for instructing printing the form to the embedding unit 74 (S1527). The embedding unit 74 sends the print instruction to the main unit 20 to via the connection I/F unit 77 (S1528, S1529). The connection I/F unit 78 of the main unit 20 sends the print instruction to the output unit 75 (S1530). In response to receiving the print instruction, the output unit 75 prints out the form having the user information embedded therein. FIGS. 16A and 16B each illustrates an example of the form printed out by the output unit 75. As illustrated in FIG. 16A, the user name and the address are embedded in the blank areas in Form 1 illustrated in FIG. 8A. Further, as illustrated in FIG. 16B, the user ID, the post, and the user name are embedded in the blank in Form 3 illustrated in FIG. 8C.

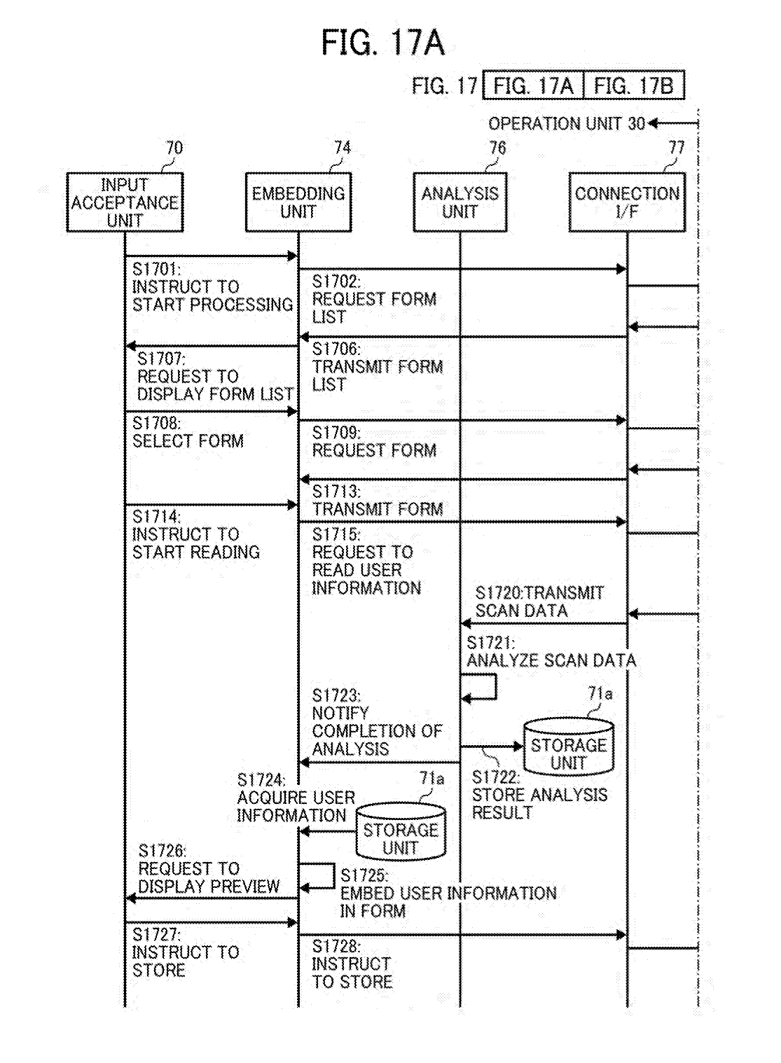

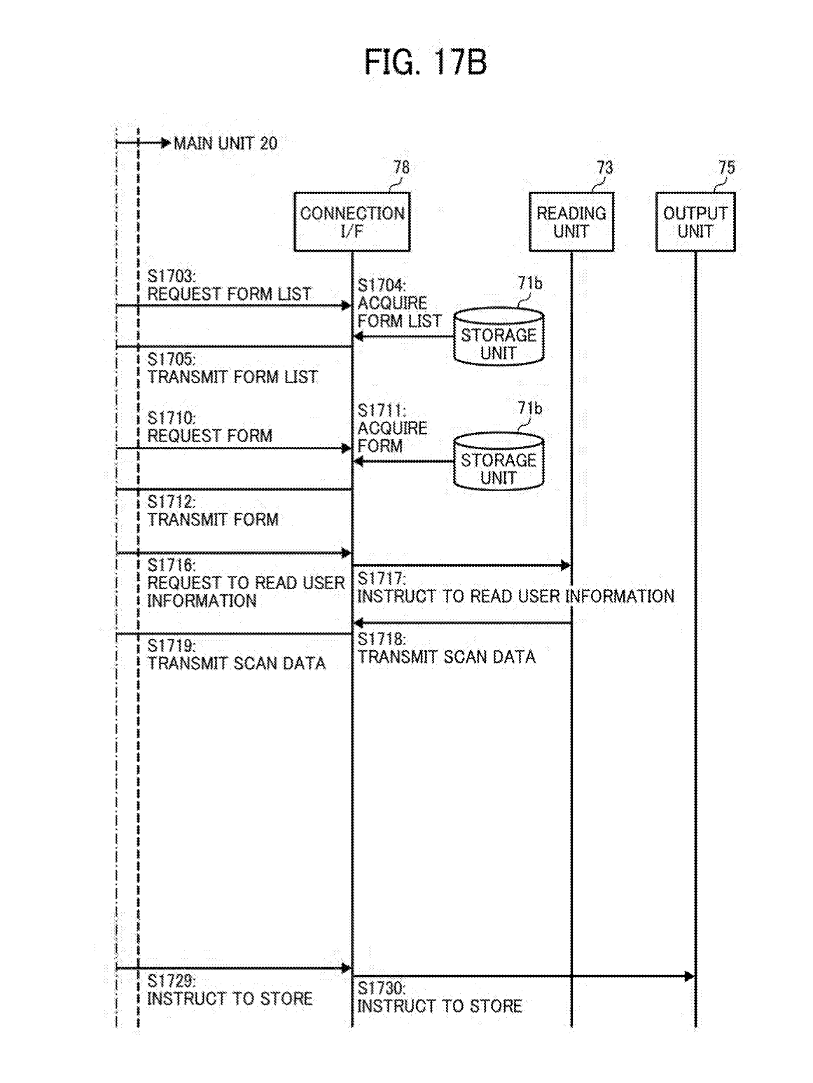

Although, with reference to FIGS. 15A and 15B, a description has been given of an example in which the output unit 75 outputs the form having the user information embedded therein, the printing out is just one example of output. Alternatively, the output unit 75 may output data of the form having the user information embedded therein to an external storage device such as a USB memory to cause the external storage to store the data. FIGS. 17A and 17B are a sequence diagram illustrating an operation performed when the data of the form having the user information embedded therein is stored in the external storage device. The processing from S1701 to S1726 is the same or substantially the same as that of S1501 to S1526, and the description thereof is omitted. In response to receiving a user instruction for storing of the data of the form having the user information embedded therein in the external device, the input acceptance unit 70 instructs the embedding unit 74 to store the data (S1727).

The embedding unit 74 sends a data storage instruction for instructing storing of the data to the main unit 20 via the connection I/F unit 77 (S1728, S1729). The connection I/F unit 78 of the main unit 20 sends the data storage instruction to the output unit 75 (S1730). In response to receiving the data storage instruction, the output unit 75 outputs the data having the user information embedded therein to the external storage device to store the data in the external storage device. Alternatively, the output unit 75 may output the data to the internal HDD 24 to store the data in the HDD 24. Still alternatively, the output unit 75 may output the data to engine 27 to fax the form having the user information embedded therein using a telephone network.

The user information may be converted directly into the two-dimensional code included in the personal information card 15. Alternatively, the user information is encoded in advance, and the encoded user information is converted into the two-dimensional code. The security is improved with the two-dimensional code obtained by converting the encoded user information. For this reason, the MFP 14 further includes an encoding unit 54 and a decoding unit 81. The description of the encoding unit 54 and the decoding unit 81 is given later. Note that, for encoding, an encryption process is performed using a predetermined encryption algorithm. Any known encryption algorithm may be used as long as the data is encrypted and the encrypted data is decrypted.

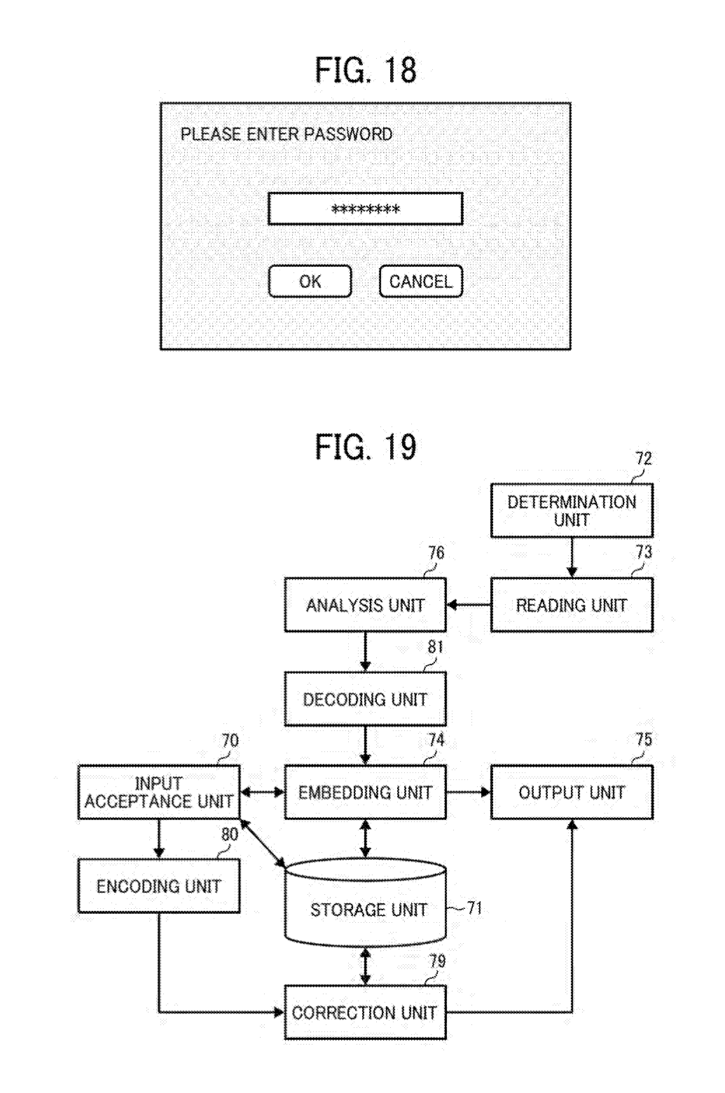

In this case in which the user information is encoded prior to the conversion into the two-dimensional code, the screen as illustrated in FIG. 7D transits, in response to a selection of the “START READING” key, to a screen as illustrated in FIG. 18, requesting a user to enter information such as a password for decoding the encoded user information. The user enters the password and selects an “OK” key on the screen illustrated in FIG. 18. The encoded user information is decoded with the password. Thus, the preview screen as illustrated in FIG. 7E is displayed on the control panel 37.

As described heretofore, the embedding unit 74 embeds the user information in each selected from. The form having the user information embedded therein is displayed for preview. Accordingly, the user's efforts of filling in the personal information by handwriting are saved when preparing forms. Further, mistakes made when handwriting the user information are reduced. Accordingly, the document is prepared with an effective manner. Note that the preview is optional, and the form having the user information embedded therein may be printed out without the preview.

If a new personal information card 15 is issued once there is a change in the address, the phone number, or the post of the user information stored in the personal information card 15, the previewed contents is output without any correction. Similarly, if the data stored in the server 11 is updated once there in a change in the address, etc., of the user information stored in the server 11, the previewed content is output without any correction. However, it is bothersome for the user to create the new personal information card 15 or update the data in the server 11 every time the address, etc., changes. Further, the user may sometimes forget to create the new personal information card 15 or update the data in the server 11. For this reason, the preview screen may include a “CORRECT” key as illustrated in FIG. 7E, enabling the user to correct the previewed content as necessary.

FIG. 19 is a block diagram illustrating still another example of the functional configuration of the MFP 14. In an example illustrated in FIG. 19, the MFP 14 further includes a correction unit 79, the encoding unit 80, and the decoding unit 81, in addition to the input acceptance unit 70, the storage unit 71, the determination unit 72, the reading unit 73, the embedding unit 74, the output unit 75, the analysis unit 76 illustrated in FIG. 5 and/or FIG. 12. Hereinafter a description is given of the correction unit 79, the encoding unit 80, and decoding unit 81, as the description of the other functional blocks has been already made above. The decoding unit 81 decodes the encrypted user information extracted from the two-dimensional code by the analysis unit 76. The encoding unit 80 encodes the user information accepted by the input acceptance unit 70. Note that the encoding unit 80 and the decoding unit 81 are optional.

The input acceptance unit 70 accepts a user instruction for instructing correcting of the user information embedded in the form by the embedding unit 74. The correction unit 79 corrects the embedded user information in accordance with the user instruction accepted by the input acceptance unit 70. In other words, the correction unit 79 updates the user information embedded in the form to reflect the correction to the user information made by the user.

Further, in a case in which the MFP 14 is connected to the network 10, the correction unit 79 updates the user information stored in the server 11 with the corrected user information. Furthermore, when the input acceptance unit 70 accepts a request from the user for creating a new personal information card 15 including the corrected information, the correction unit 79 acquires the corrected user information from the storage unit 71, generates the two-dimensional code, which is an image that is not perceptible to the naked human eye, and instructs the output unit 75 to print out the new personal information card 15 having the two-dimensional code.

Accordingly, the MFP 14 having the correction unit 79 is able to update the user information of each user and create the new personal information card 15.

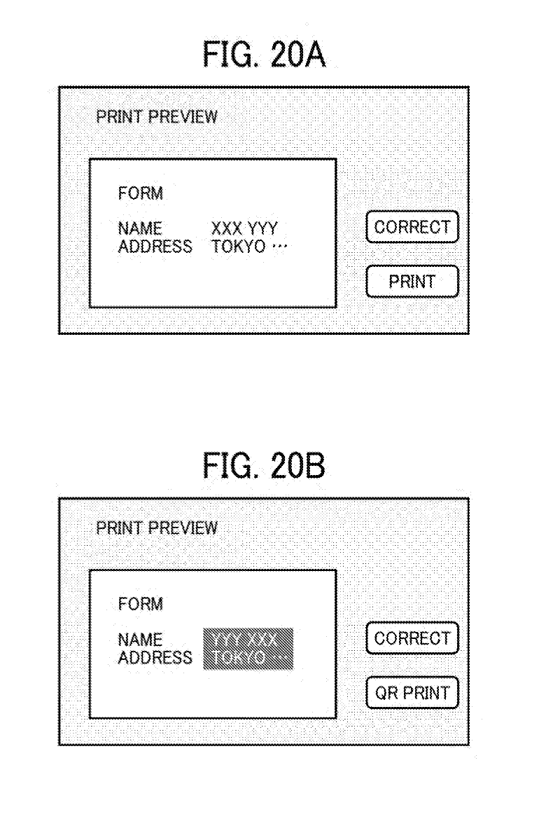

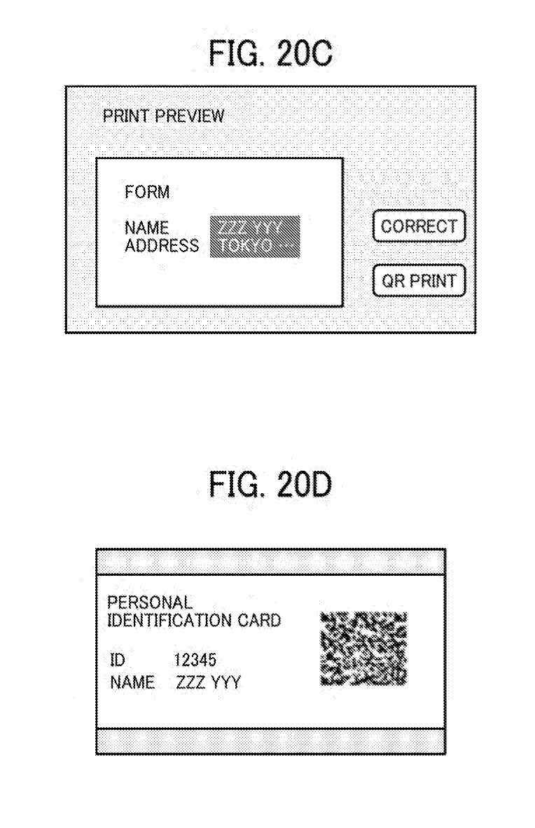

FIGS. 20A to 20D illustrate examples of a screen displayed on the control panel 37 when the correction is made to the user information embedded in the form in accordance with the user instruction via the preview screen. A screen illustrated in FIG. 20A is the same preview screen as that illustrated in FIG. 7E. When the user wants to correct the user information displayed on the preview screen, the user selects the “CORRECT” key. In response to the user selection of the “CORRECT key”, the preview screen as illustrated in FIG. 20A transits to a screen as illustrated in FIG. 20B. As illustrated in FIG. 20B, an area including the embedded user information is reversed from black texts with a white background to white texts with a black background. The user information in the reversed area is corrected in accordance the user input. Although, in FIG. 20B, the text and the background are reversed to make it easy for the user to recognize that the user can correct the user information on the screen, this reverse display is just one example.

The user corrects the user information in the reversed area using hardware key provided with the MFP 14 or a virtual keyboard displayed on the control panel 37. The input acceptance unit 70 accepts the category to be corrected and the correction content. The input acceptance unit 70 passes the category to be corrected and the correction content to the correction unit 79. The correction unit 79 corrects the user information embedded on the form based on the category and the correction content received from the input acceptance unit 70. Further, the correction unit 79 instructs the input acceptance unit 70 to display the preview reflecting the correction.

FIG. 20C illustrates a preview screen displaying the form having the corrected user information. The user repeats the correction as necessary and selects a “QR PRINT” key when the user no more want to correct the user information displayed on the preview screen. FIG. 20D illustrates an example of the new personal information card 15 having the QR code (registered trademark) that is printed out in response to the selection of the “QR PRINT”.

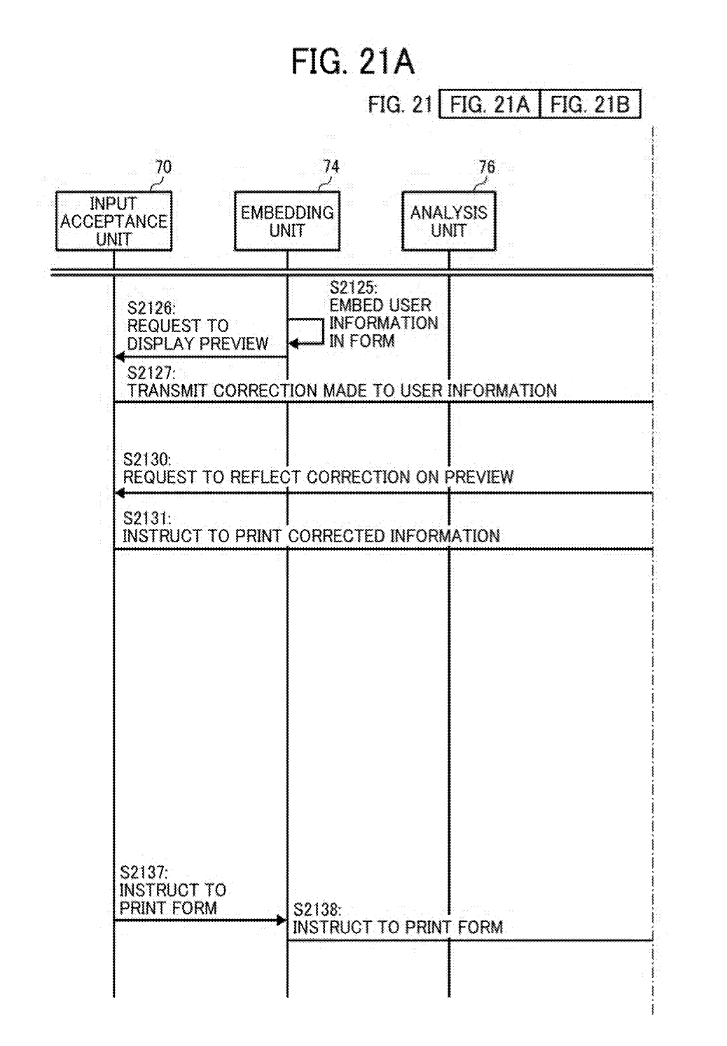

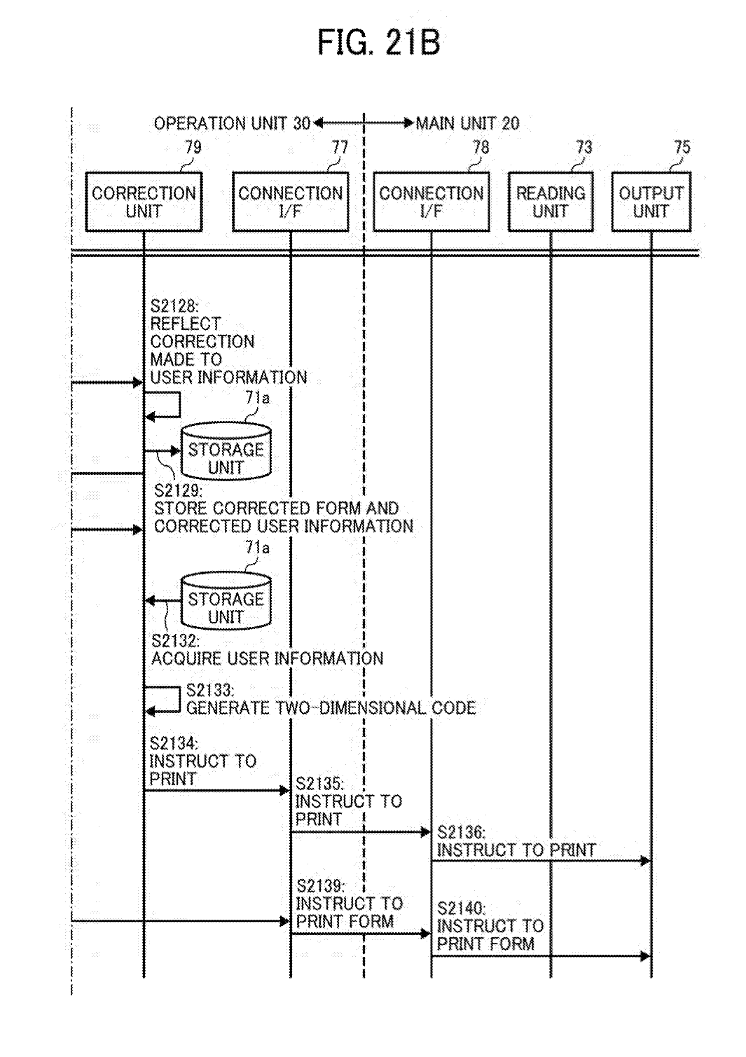

FIGS. 21A and 21B are a sequence diagram illustrating an operation performed by the MFP 14 including the correction unit 79. The MFP 14 performs the same or substantially the same processing from S1501 to S1524 of FIGS. 15A and 15B.

Subsequently, the embedding unit 74 embeds the user information in the form acquired in advance (S2125). Further, the embedding unit 74 passes the form having the user information embedded therein to the input acceptance unit 70 to request displaying of the preview screen (S2126). In response to receiving the request, the input acceptance unit 70 causes the control panel 37 to display the preview screen as illustrated in FIG. 20A.

The input acceptance unit 70 receives the user instruction for correcting the user information embedded in the form and sends the correction content to the correction unit 79 (S2127). The correction unit 79 corrects the user information embedded in the form based on the correction content (S2128). Further, the correction unit 79 stores the corrected user information and the form having the corrected user information embedded therein in the storage unit 71a (S2129). The correction unit 79 instructs the input acceptance unit 70 to update the preview screen to reflect the correction content (S2130). In response to receiving the instruction, the input acceptance unit 70 causes the control panel 37 to display the preview screen reflecting the correction content as illustrated in FIG. 20C.

When the user agrees with the displayed content, the user gives an instruction for printing out the corrected information via the control panel 37. In response to receiving the user instruction, the input acceptance unit 70 sends an instruction for printing of the corrected information to the correction unit 79 (S2131). In response to receiving the instruction from the input acceptance unit 70, the correction unit 79 acquires the user information from the storage unit 71a (S2132). The correction unit 79 converts the acquired user information to generate the two-dimensional code (S2133). The correction unit 79 sends an instruction for printing out the personal information card 15 containing the generated two-dimensional code to the connection I/F unit 77 (S2134). The connection I/F unit 77 sends the print instruction to the main unit 20 (S2135). In response to receiving the instruction, the connection I/F unit 78 of the main unit 20 instructs the output unit 75 to print out the personal information card 15 (S2136).

The input acceptance unit 70 accepts the user instruction for printing out the form having the corrected user information embedded therein. The input acceptance unit 70 sends the print instruction to the embedding unit 74 (S2137). The embedding unit 74 sends the print instruction to the main unit 20 via the connection I/F unit (S2138, S2139). In response to the print instruction, the connection I/F unit 78 of the main unit 20 instructs the output unit 75 to print out the form (S2140). Accordingly, the output unit 75 prints out the form having the updated user information embedded therein.

The encoding unit 80 as described above encrypts the corrected user information. In this case, the correction unit 79 converts the encrypted corrected user information into the two-dimensional code. The reading unit 73 reads the two-dimensional code to generate the scan data. The analysis unit 76 analyzes the scan data to extract the encrypted corrected user information. The decoding unit 81 decrypts the encrypted corrected user information extracted by the analysis unit 76.

To further improve the security, the MFP 14 may require the user to set the password used for decrypting the encrypted corrected user information that is different the password used for encrypting the user information before the correction. For example, in response to the user selection of the “QR PRINT” key on the screen illustrated in FIG. 20C, or in other words, at S2131 in the sequence diagram of FIGS. 21A and 21B, the input acceptance unit 70 displays the screen as illustrated in FIG. 18 on the control panel 37, requesting the user to input the password. When the input password is identical with the one used for encrypting the user information before the correction, the input acceptance unit 70 displays a warning and again displays the screen that requests the user to enter the password on the control panel 37.

As described heretofore, with the information output apparatus, the information output system, and the information processing apparatus and the image forming apparatus used in the information output system according to the embodiments of the present invention, the user information is acquired and embedded in the selected form, and the form having the user information embedded therein is output, even in an environment disconnected from a network. Further, the user is able to check the user information embedded in the form before outputting and correct the embedded user information as necessary. Furthermore, the content of the corrected user information is printed out to provide the personal information card having the updated user information. Still further, the two-dimensional code is read to extract the user information. Thus, the security is improved. In addition, the encryption of the user information further improves the security.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Accordingly, the information output apparatus, the information output system, the information processing apparatus, the image forming apparatus, and program according to the above-described embodiments may be applied to a method for outputting information, a computer-readable medium storing the above-described program, a server that provides the program, etc.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information output apparatus comprising:
a reader to read user information from a recording medium storing the user information; and
circuitry to:
select, from a plurality of documents, one or more documents to be embedded with the user information as a selected document,
determine whether the information output apparatus is connected to a network,
instruct the reader to read the user information from the recording medium based on a determination indicating that the information output apparatus is not connected to the network, and
embed the user information that is read from the recording medium in a specific area of the selected document; and
an output device to output the selected document having the user information embedded therein.

2. The information output apparatus of claim 1, further comprising:
a memory to store, for each of the plurality of documents available for selection by a user, document data of the document in association with a category of the user information to be embedded in the document and the specific area of the document in which the user information is to be embedded; and
a display to display the plurality of documents for selection by the user, wherein the circuitry is further configured to:
accept a selection of the one or more documents as the selected document, from the plurality of documents being displayed on the display; and
for each of the one or more documents as the selected document,
obtain, from among the user information read from the recording medium, a user information item associated with the document data of the selected document, and
embed the obtained user information item in the specific area associated with the document data of the selected document.

3. The information output apparatus of claim 1, wherein, when the recording medium is a paper medium having an image printed thereon,
the reader reads the image on the paper medium to generate image data, and
the circuitry is further configured to analyze the image data to extract the user information.

4. The information output apparatus of claim 1, wherein the circuitry is further configured to:
accept a correction request for requesting correction of the user information embedded in the selected document; and
correct the user information embedded in the selected document in accordance with the correction request.

5. The information output apparatus of claim 4, wherein the circuitry is further configured to:
generate an image using the corrected user information in response to a user instruction; and
instruct the output device to print out the generated image having the corrected user information.

6. The information output apparatus of claim 5, wherein the circuitry is further configured to:
encode the corrected user information; and
generate the image using the encoded corrected user information.

7. The information output apparatus of claim 1, wherein, when the user information stored in the recording medium is encoded in advance,
the circuitry is further configured to:
accept an input of information to be used for decoding the user information encoded in advance; and
decode the user information read by the reader using the input information.

8. The information output apparatus of claim 1, further comprising a transmitter to transmit a connection request to the network, wherein
the circuitry determines whether the information output apparatus is connected to the network based on a determination of whether the network sends a reply to the connection request transmitted by the transmitter.

9. A non-transitory computer-readable medium storing a computer-executable program that, when executed, causes a computer to perform a method of outputting information, the method comprising:
selecting, from a plurality of documents, one or more documents to be embedded with user information as a selected document;
determining whether the computer is connected to a network;
reading the user information from a recording medium storing the user information based on a determination indicating that the computer is not connected to the network;
embedding the user information that is read from the recording medium in a specific area of the selected document; and
outputting the selected document having the user information embedded therein.

10. The non-transitory computer-readable medium of claim 9, further comprising:
storing, in a memory, for each of the plurality of documents available for selection by a user, document data of the document in association with a category of the user information to be embedded in the document and the specific area of the document in which the user information is to be embedded;
displaying the plurality of documents for selection by the user;
accepting a selection of the one or more documents as the selected document, from the plurality of documents being displayed on the display; and
for each of the one or more documents as the selected document,
obtaining, from among the user information read from the recording medium, a user information item associated with the document data of the selected document; and
embedding the obtained user information item in the specific area associated with the document data of the selected document.

11. The non-transitory computer-readable medium of claim 9, wherein, when the recording medium is a paper medium having an image printed thereon,
the method further comprising:
reading the image on the paper medium to generate image data; and
analyzing the image data to extract the user information.

12. The non-transitory computer-readable medium of claim 9, wherein the method further comprising:
accepting a correction request for requesting correction of the user information embedded in the selected document; and
correcting the user information embedded in the selected document in accordance with the correction request.

13. The non-transitory computer-readable medium of claim 9, wherein the method further comprising:
generating an image that is not perceptible to a naked human eye using the corrected user information in response to a user instruction; and
printing out the generated image having the corrected user information.

14. The non-transitory computer-readable medium of claim 13, wherein the method further comprising:
encoding the corrected user information; and
generating the image using the encoded corrected user information.

15. The non-transitory computer-readable medium of claim 9, wherein, when the user information stored in the recording medium is encoded in advance,
the method further comprising decoding the encoded user information read from the recording medium.

16. The non-transitory computer-readable medium of claim 9, wherein the method further comprising:
transmitting a connection request to the network: and
determining whether the computer is connected to the network based on a determination of whether the network sends a reply to the connection request.

17. A method of outputting information performed by a computer, comprising:
selecting, from a plurality of documents, one or more documents to be embedded with user information as a selected document;
determining whether the computer is connected to a network;
reading the user information from a recording medium storing the user information based on a determination indicating that the computer is not connected to the network;
embedding the user information that is read from the recording medium in a specific area of the selected document; and
outputting the selected document having the user information embedded therein.
